(19) United States
(12) Patent Application Publication
(10) Pub. No.: US 2008/0089567 A1
(43) Pub. Date: Apr. 17, 2008

(54) ARTIFACT REDUCTION IN AN X-RAY IMAGING SYSTEM

(76) Inventors: Tracy K. Eliasson, Boulder, CO (US); Dean C. Buck, Loveland, CO (US)

Correspondence Address: AGILENT TECHNOLOGIES INC., INTELLECTUAL PROPERTY ADMINISTRATION,LEGAL DEPT., MS BLDG. E P.O. BOX 7599, LOVELAND, CO, 80537, US

(21) Appl. No.: 11/548,606

(22) Filed: Oct. 11, 2006

(51) Int. Cl. G06K 9/00; G06K 9/40

(52) U.S. Cl. 382/128; 382/275

(57) ABSTRACT

A scanning X-ray system minimizes frequency artifacts by capturing a first and a second image that are offset in at least one direction.

### BACKGROUND

In the electronics industry, X-Ray-based machine vision systems are used to inspect the inside of integrated circuit packages to assure package and interconnect integrity, to align board layers in multilayer manufacturing, to inspect multilayered boards before hole drilling to qualify hole-pad alignment and to inspect solder joints. With the increased adoption of chip scale technology, such as ball grid arrays, and the result that solder joint interconnects are hidden from view there is no way that people really perform a comprehensive inspection. Similarly, conventional machine vision systems can not see the hidden solder joints.

In a prior art X-ray area mode system, the X-ray source is moved circularly. The detector moves circularly. Images are captured at different angles during rotation. The combined images are well-distributed around the circle. The object under test is positioned in the only plane whose shadow is stationary on the moving detector. This plane is called the “plane of focus” (POF). Thus, images of the object in the POF are reinforced while images of the object outside the POF are smeared. The system has no ability to reduce artifacts caused by multiple object features of the same shape whose locations are at regular spacing. These artifacts are produced by the superposition of the harmonic frequencies and are more severe as the frequencies come into phase. Harmonic frequencies include the fundamental frequency as well as the multiples of the fundamental frequency.

### SUMMARY

An X-Ray tube directs a beam thru an object towards a detector. The detector converts x-rays to a digital image referred as a projection image. The projection image is received by a processor. The processor receives several projection images and generates a slice image from the projection images. The slice image may be further analyzed, e.g. using classifying software, or displayed.

The locations for imaging the object are selected to minimize artifacts. The object is imaged generating projection images. A subset of the projection images is selected. This subset is used to form a slice image.

### BRIEF DESCRIPTION OF THE DRAWINGS

FIG. 1 illustrates a block diagram of a line scanning X-ray system.

FIG. 2 is a process flowchart that describes the image collection process.

### DETAILED DESCRIPTION

The invention is directed towards X-ray imaging systems. While the illustrative example is a line scanning x-ray system, one of ordinary skill can extend the concepts presented to an area mode x-ray system or any scanning system that captures projection images. Projection images are transmissive images where an A and a B side are superimposed on each other within the image. The multiple projection images are combined to produce a slice image. In the slice image, one slice, such as the B side image, is reinforced while other slices, including the A side image, are “smeared out”.

X-ray inspection displays gray-scale images that represent variances in the shape and thickness of an object. The gray levels in the image can be directly related to objects density and thickness. Therefore, the features may be quantitatively measured and a correlation between acceptable or unacceptable manufacturing process conditions may be determined.

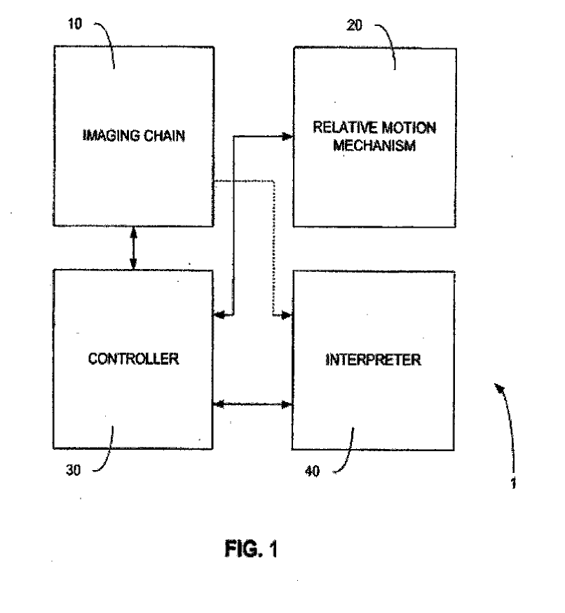

An example of an x-ray inspection system 1 is shown in FIG. 1. An imaging chain 10 is employed to obtain x-ray images of an article under inspection, e.g. an electronic printed circuit board (PCB). A relative motion mechanism 20 is used to maneuver the article under inspection in relation to the imaging chain 10 so that various areas of the article may be inspected. An interpreter 40 then takes the x-ray images as input to generate a series of layer images, each exposing a separate conceptual “layer” of the article. The interpreter 40 may then process such images in order to ascertain the overall quality of the article under inspection by comparing the resulting layer images with a preexisting database that the interpreter 40 uses as a comparative model. A controller 30 is used to coordinate the actions of the imaging chain 10, the relative motion mechanism 20, and the interpreter 40. The controller 30 may also be used to facilitate the transfer of image data between the imaging chain 10 and the interpreter 40.

During inspection, X-rays emitted from the source pass through the object, e.g. a circuit board. The X-rays are then passed through a scintillating material that transforms the X-rays to light. The light is then collected by a detector. The output of the detector is a projection image which is sent to a processor. The processor generates a slice image from the projection images. The slice images are processed for display, enhancement, and analysis. X-ray inspection can reveal a number of defects, whether hidden or visible, e.g. open or shorted solder joints, lifted leads, component misregistration.

While the invention will be described for a system where the stage moves the board perpendicular to the length of a line scan detector, the concept is extendible to a system where there is relative movement between the board and detector. The direction parallel to the length of a line scan detector is the X-axis. Thus, the Y-axis is perpendicular to the line scan detector.

In a line scanning X-ray system, projection x-ray images are collected while the stage scans the board in a direction perpendicular to the length of the detector. Projections are combined (shifted and added or any other method known to those skilled in the art) after they have been collected. First, a reference plane is established. Additional shifts are needed to create a slice at some other height. The amount of shift depends on the stage x location, detector y location, and z height of the slice that is desired. Frequency artifacts occur on double sided panels when shadows of regularly spaced solder joints on side “A” interfere while trying to create slice images for joints on side “B”. Side “B” is offset from side “A” in the z direction. This is very common with ball grid array (BGA) and column grid array (CGA) systems. It is also common when a group of the same component is placed in a group on the panel, e.g. a row or column of capacitors.

$$\begin{matrix}Δ Xshift = Z * {X}_{stage} * ( \frac{1}{{z}_{2}} - \frac{1}{{z}_{1}} ) * \frac{1}{{p}_{cam}} & Equation 1 \\ Δ Yshift = \frac{( {Y}_{2} - {Y}_{1} )}{Z} * Δ ( {z}_{z} - {z}_{1} ) * ( \frac{1}{{p}_{scan}} ) & Equation 2\end{matrix}$$

Z is the vertical distance from the X-ray source to the detector array. Z₁ is the vertical distance from the x-ray source to the reference plane. Z₂ is the vertical distance from the X-ray source to the plane of focus. pcam is the pixel size at the detector. Y₂-Y₁ is the location of detector 2 relative to detector 1 in the detector array plane. pscan is the pixel size in the scanning direction.

Vertical frequency artifacts occur under two conditions. First, frequency artifacts occur when joints are imaged during the same scan pass on more than one detector because the x position of the stage is equal for each of the projections. This makes ΔXshift equal for these projections, regardless of z height. Second, frequency artifacts occur when x location of the stage between passes is regular.

Horizontal frequency artifacts occur under three conditions. First, frequency artifacts occur when two or more detectors are at the same y position within the detector array. Second, frequency artifacts occur when a given joint is imaged on the same detector twice. Thus, the images are captured at the same y location twice. Third, they occur when regular spacing between the detectors y positions exists.

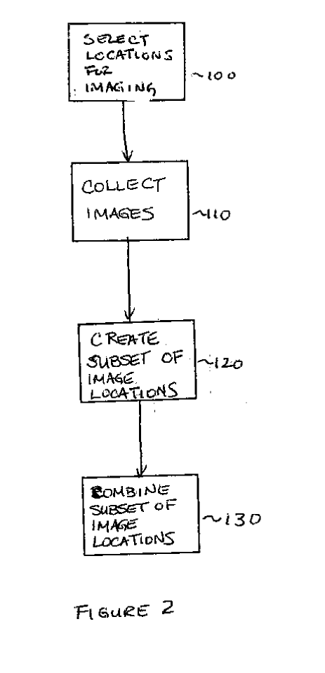

FIG. 2 is a process flowchart that describes the image collection process. In step 100, select locations for imaging. In step 110, collect images. In step 120, choose subset of the images. In step 130, combine the subset of the images to form a slice image.

Thus, for an X-ray system, in step 100, the scanning locations are chosen to minimize frequency artifacts either vertically, horizontally, or in both directions.

When the x-ray imaging system is a line scanning system, the frequency artifacts may be minimized as follows. To reduce vertical frequency artifacts, the detector positions along an X axis are chosen to minimize the number of images of the same area of the article captured during one scan pass. To reduce horizontal frequency artifacts, the detector positions along a Y axis have been chosen to avoid regular spacing of detectors in the y direction.

When the X-ray imaging system is an area mode x-ray system that includes with multiple area mode detectors; frequency artifacts are minimized by selecting detector locations in Cartesian space that are irregularly spaced. Alternatively, for an area mode X-ray system having a single large detector, the large detector may be divided into sub-regions such that sub-region spacing not regular.

Frequency artifacts may be further minimized during image combination as follows. As described in step 120, a subset of captured images is selected for combination such that there is a projection for each x position. Alternatively, subset of captured images may be selected such that the slice heights, e.g. imaging heights, of the captured images vary. The combination may be selected to minimize artifacts at a specific z-height or the detector locations can be selected to minimize the artifacts over a range of heights. To illustrate, the range of slice heights maybe optimized for a horizontal slice in the object space where the unit under test resides or the range of slice heights may be optimized for a specific slice height in the object space where the unit under test resides.

In particular, for an area mode X-ray system, the detector locations are selected to minimize the vertical frequency artifacts while for a line scanning system the pass locations are optimized to reduce vertical frequency artifacts. For both line scanning and area mode X-ray systems, the detector locations correspond to horizontal frequency artifacts.

In an X-ray scanning system, the vertical frequency artifacts are reduced by selecting positions of the detector along the X-axis to minimize the number of intersecting detectors during any individual pass. To reduce horizontal frequency artifacts, the positions of the detector along the Y-axis are selected to avoid harmonic spacing.

In an area mode X-ray system, the PCA, the device under test, locations are selected to avoid harmonic spacing. Harmonic spacing includes the fundamental frequency as well as the multiples of the fundamental frequency. Alternatively, a single imaging array may be implemented such that the position of the panel during successive projection capture is chosen to avoid harmonic spacing.

1. An apparatus comprising:
an x-ray imaging system is one of a line scanning x-ray system and an area mode X-ray system;
wherein locations for imaging an object have been chosen to minimize one of vertical and horizontal artifacts.

2. An apparatus, as in claim 1, wherein images are captured such that an artifact is minimized, wherein the artifact is selected from a group including a range of slice heights and a specific slice height.

3. An apparatus, as in claim 1, wherein artifacts are minimized at one of a specific slice height for a slice within a device under test and a specific slice height range near a slice within a device under test.

4. An apparatus as in claim 1, wherein:
the x-ray imaging system is the line scanning x-ray system; and
detector positions along an X axis have been chosen such that a minimum number of detectors image any one object during one pass to minimize vertical frequency artifacts.

5. An apparatus, as in claim 1, wherein:
the X-ray imaging system is a line scanning system; and
detector positions along a Y axis have been chosen to avoid harmonic spacing of detectors in the y direction to minimize horizontal frequency artifacts.

6. An apparatus, as in claim 1, wherein:
the X-ray imaging system is an area mode x-ray system; and
detector locations in Cartesian space are chosen to avoid harmonic spacing between detectors to minimize frequency artifacts.

7. An apparatus, as in claim 6, wherein:
the detectors are subregions of one or more larger area mode detectors.

8. A method comprising:
for an X-ray imaging system, wherein the X-ray imaging system is one of a line scanning system and an area mode X-ray system;
selecting locations for imaging;
capturing a set of projection images at positions offset from one another in two directions;
selecting a subset of the images; and
combining the subset of images.

9. A method, as in claim 8, wherein:
the X-ray scanning system is a line scanning system;
the subset is selected such that there are a limited number of projections for each scanning location.

10. A method, as in claim 9, wherein the subset is selected such that an artifact is minimized, wherein the subset is selected from a group including a range of slice heights and a specific slice height.

11. A method, as in claim 9, wherein artifacts are minimized at one of a specific slice height for a slice within a device under test and a specific slice height range near a slice within a device under test.

12. A method comprising:
for an X-ray imaging system, wherein the X-ray imaging system is one of a line scanning system and an area mode X-ray system;
selecting locations for imaging such that step sizes between locations are non-harmonically spaced;
capturing a set of projection images; and
combining the set of images.

13. A method, as in claim 12, wherein:
the X-ray scanning system is a line scanning system;
the locations are selected such that there are a limited number of projections for each scanning location.

14. A method, as in claim 12, wherein the locations are selected such that an artifact is minimized, wherein the locations are selected from a group including a range of slice heights and a specific slice height.

15. A method, as in claim 12, wherein artifacts are minimized at one of a specific slice height for a slice within a device under test and a specific slice height range near a slice within a device under test.
